(19) United States
(12) Patent Application Publication
(10) Pub. No.: US 2026/0142089 A1
(43) Pub. Date: May 21, 2026

(54) MULTILAYER ELECTRONIC COMPONENT

(71) Applicant: SAMSUNG ELECTRO-MECHANICS CO., LTD., Suwon-si (KR)

(72) Inventors: Young Jun CHA, Suwon-si (KR); Hyun Soo OH, Suwon-si (KR)

(73) Assignee: SAMSUNG ELECTRO-MECHANICS CO., LTD., Suwon-si (KR)

(21) Appl. No.: 19/310,142

(22) Filed: Aug. 26, 2025

(30) Foreign Application Priority Data
Nov. 20, 2024 (KR) 10-2024-0165785

(51) Int. Cl. H01G 4/30; H01G 4/012; H01G 4/232

(52) U.S. Cl. CPC H01G 4/30; H01G 4/012; H01G 4/232

(57) ABSTRACT

A multilayer electronic component includes a body including a dielectric layer and internal electrodes an electrode penetrating through the body to be disposed on the body and connected to the internal electrodes, wherein the electrode includes a first electrode layer disposed on the body and including a first conductive metal as a main component, a second electrode layer penetrating through the body to contact the internal electrodes and including a second conductive metal as a main component, and a third electrode layer contacting the second electrode layer and penetrating through the body to be disposed on the first electrode layer and including a third conductive metal as a main component, and the second and third conductive metals are different metals.

### CROSS-REFERENCE TO RELATED APPLICATION(S)

This application claims benefit of priority to Korean Patent Application No. 10-2024-0165785 filed on Nov. 20, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type capacitor mounted on the printed circuit boards of various types of electronic products such as imaging devices including liquid crystal displays (LCDs) and plasma display panels (PDPs), computers, smartphones, cell phones, and the like, to allow electricity to be charged therein and discharged therefrom.

Such an MLCC may be used as a component of various electronic devices due to advantages thereof such as compactness, guaranteed high capacitance, and ease of mounting. As various electronic devices such as computers and mobile devices have been reduced in size and increased in power, demand for miniaturization and high capacitance of multilayer ceramic capacitors have been increased.

Meanwhile, MLCCs have also been widely used for decoupling to remove noise from electric signals within a set due to excellent high-frequency characteristics (low equivalent series inductance (ESL)).

In addition, in order to solve the noise of high-speed integrated circuits (ICs), a type of MLCC known as a land side capacitor (LSC) may be disposed adjacent to the IC. It is s known that LSCs or low inductance ceramic capacitors (LICCs) require a low thickness, high-frequency characteristics (low ESL), and low equivalent series resistance (low ESR).

For low ESL, it is important to minimize the number of magnetic flux linkages per unit current in a high-frequency range. To this end, various methods have been used to solve this problem, such as controlling a structure in the direction of minimizing a current loop or arranging internal electrodes and electrodes in the direction of canceling a magnetic field. In addition, for low ESR, methods, such as arranging internal electrodes and electrodes in the direction of minimizing the loop current, have been applied.

As mentioned above, since LSCs have been generally disposed below an IC substrate, LSCs are required to have a low thickness while having low ESL and appropriate ESR. Here, an LSC is mounted on the spot in which a solder ball below the substrate is removed or inside the substrate, and in the related art, a capacitor in the form of an LICC has been mainly used, but the need for a capacitor having a square form factor has gradually increased.

### SUMMARY

An aspect of the present disclosure is to improve high-frequency characteristics (low ESL) of a multilayer electronic component.

Another aspect of the present disclosure is to achieve low equivalent series resistance (ESR) characteristics in a multilayer electronic component.

Another aspect of the present disclosure is to reduce the size of a multilayer electronic component.

Another aspect of the present disclosure is to improve capacitance characteristics of a multilayer electronic component.

Another aspect of the present disclosure is to improve reliability of a multilayer electronic component.

However, the problems to be solved by the present disclosure are not limited to the aforementioned contents and may be more easily understood in the process of describing specific embodiments of the present disclosure.

According to an aspect of the present disclosure, a multilayer electronic component includes: a body including a dielectric layer and internal electrodes alternately arranged with the dielectric layer in a first direction and including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an electrode penetrating through the body in the first direction to be disposed on the first and second surfaces and connected to the internal electrodes, wherein the electrode includes a first electrode layer disposed on the first and second surfaces and including a first conductive metal as a main component, a second electrode layer penetrating through the body in the first direction to contact the internal electrodes and including a second conductive metal as a main component, and a third electrode layer contacting the second electrode layer and penetrating through the body in the first direction to be disposed on the first electrode layer and including a third conductive metal as a main component, wherein the second and third conductive metals are different metals.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIG. 2 is a plan view of FIG. 1;

FIG. 3 is a cross-sectional view taken along line I-I′ of FIG. 1;

FIGS. 4A and 4B schematically illustrate cross-sectional views of internal electrodes; and

FIGS. 5A to 5C schematically illustrate plan views of multilayer electronic components according to various embodiments of the present disclosure.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the Z-direction may be defined as a stacking direction, a first direction, or a thickness T-direction, the X-direction as a second direction or a length L-direction, and the Y direction as a third direction or a width W-direction.

### Multilayer Electronic Component

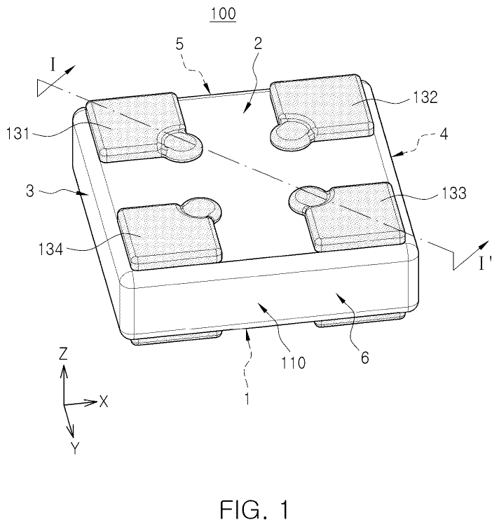

FIG. 1 is a perspective view schematically illustrating a multilayer electronic component according to an embodiment of the present disclosure;

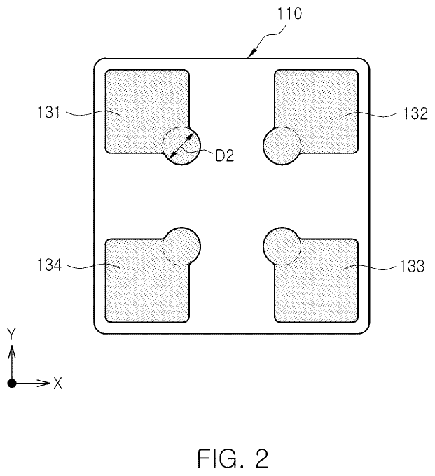

FIG. 2 is a plan view of FIG. 1;

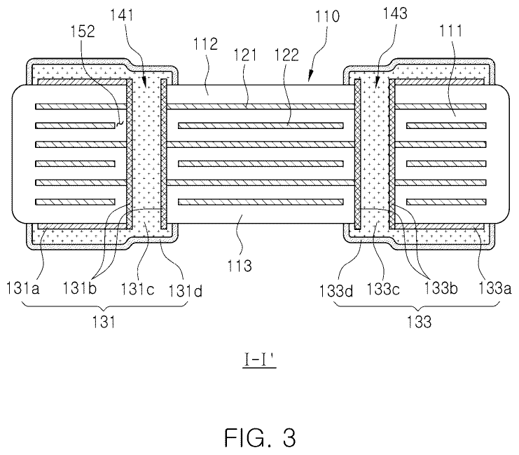

FIG. 3 is a cross-sectional view taken along line I-I′ of FIG. 1;

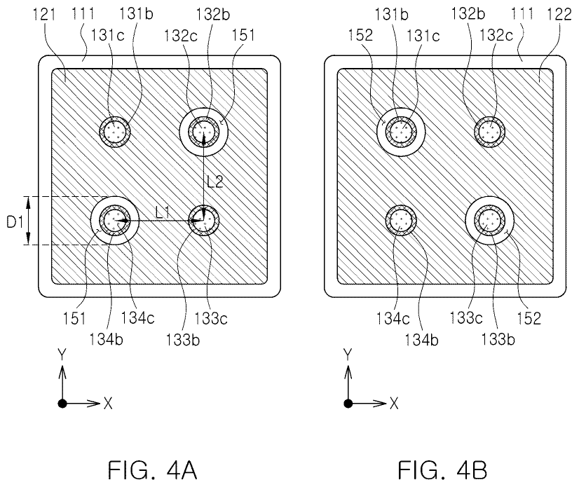

FIGS. 4A and 4B schematically illustrate cross-sectional views of internal electrodes; and

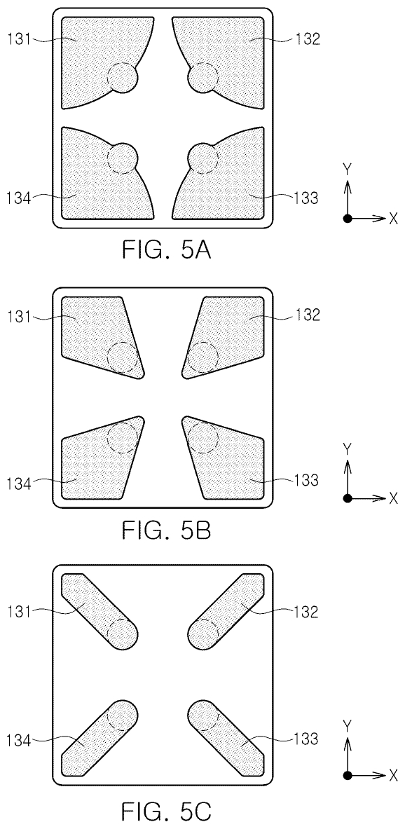

FIGS. 5A to 5C schematically illustrate plan views of multilayer electronic components according to various embodiments of the present disclosure.

Hereinafter, a multilayer electronic component according to an embodiment of the present disclosure will be described in detail with reference to FIG. 1 to FIG. 5C. However, a multilayer ceramic capacitor is described as an example of a multilayer electronic component, but the present disclosure may also be applied to various electronic products using a dielectric composition, such as inductors, piezoelectric elements, varistors, or thermistors.

A multilayer electronic component 100 according to an embodiment of the present disclosure includes a body 110 including a dielectric layer 111 and internal electrodes 121 and 122 alternately arranged with the dielectric layer 111 in the first direction and including first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction; and electrodes 131, 132, 133, and 134 penetrating through the body 110 in the first direction to be disposed on the first and second surfaces 1 and 2 and connected to the internal electrodes 121 and 122, wherein the electrodes 131, 132, 133, and 134 include first electrode layers 131a, 132a, 133a, and 134a disposed on the first and second surfaces 1 and 2 and including a first conductive metal as a main component, second electrode layers 131b, 132b, 133b, and 134b penetrating through the body 110 in the first direction to contact the internal electrodes 121 and 122 and including a second conductive metal as a main component, and third electrode layers 131c, 132c, 133c, and 134c contacting the second electrode layers 131b, 132b, 133b, and 134b and penetrating through the body 110 in the first direction to be disposed on the first electrode layers 131a, 132a, 133a, and 134a and including a third conductive metal as a main component, wherein the second and third conductive metals may be different metals.

Hereinafter, an embodiment of the present disclosure will be described in more detail, and for the convenience of description, structures not shown in the drawings may be described by using reference numerals, but those skilled in the art may be able to understand appropriately by referring to the distinguishing reference numerals.

In the body 110, the dielectric layers 111 and the internal electrodes 121 and 122 may be alternately stacked.

More specifically, the body 110 may include a capacitance formation portion forming capacitance, including the first internal electrode 121 and the second internal electrode 122 arranged inside the body 110 and alternately arranged to face each other with the dielectric layer 111 interposed therebetween.

Although a specific shape of the body 110 is not particularly limited, as shown, the body 110 may have a hexahedral shape or a shape similar thereto. Due to the shrinkage of ceramic powder particles included in the body 110 during a sintering process, the body 110 may not have a perfectly straight hexahedral shape but may have a substantially hexahedral shape.

The body 110 may have first and second surfaces 1 and 2 facing each other in the first direction, third and fourth surfaces connected to the first and second surfaces 1 and 2 and facing each other in the second direction, and fifth and sixth surfaces connected to the first to fourth surfaces 1, 2, 3, and 4 and facing each other in the third direction.

The plurality of dielectric layers 111 forming the body 110 are in a sintered state, and adjacent dielectric layers 111 may be integrated such that boundaries therebetween may not be readily apparent without using a scanning electron microscope (SEM).

A material for forming the dielectric layer 111 is not limited as long as sufficient electrostatic capacitance may be obtained. In general, perovskite (ABO₃)-based materials may be used, and for example, a barium titanate-based material, a lead composite perovskite-based material, or a strontium titanate-based material may be used. The barium titanate-based material may include a BaTiO₃-based ceramic powder particles, and the ceramic powder particles may include BaTiO₃ and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca, Zr, and the like are partially dissolved in BaTiO₃.

In addition, as a material for forming the dielectric layer 111, various ceramic additives, organic solvents, binders, dispersants, etc. may be added to powder particles, such as barium titanate (BaTiO₃), according to purposes of the present disclosure.

Meanwhile, to be distinguished from the dielectric layer included in the cover portions 112 and 113 described below, the dielectric layer 111 included in the capacitance formation portion may be defined as a first dielectric layer, and the dielectric layer included in the cover portions 112 and 113 may be defined as a second dielectric layer, and the first dielectric layer and the second dielectric layer may be the same or different and are not particularly limited.

In addition, since the first and second dielectric layers may be formed using a dielectric material, such as barium titanate (BaTiO₃), the first and second dielectric layers may include a dielectric microstructure after firing. The dielectric microstructure may include a plurality of dielectric crystal grains, a crystal grain boundary disposed between the adjacent dielectric crystal grains, and n-points disposed at points at which three or more of the grain boundaries contact each other and may include a plurality of dielectric crystal grains, a plurality of grain boundaries, and a plurality of n points.

A first-direction dimension of the dielectric layer 111 may not need to be particularly limited.

However, in more easily order to achieve miniaturization and high capacitance of the multilayer electronic component, the first-direction dimension of the dielectric layer 111 may be 3.0 μm or less, 2.0 μm or less, 1.0 μm or less, 0.8 μm or less, 0.6 μm or less, 0.5 μm or less, or 0.4 μm or less.

Here, the first-direction dimension of the dielectric layer 111 may be a concept including the first-direction dimension of at least one of the plurality of dielectric layers 111 or may be a concept including the first-direction dimension of each of all the dielectric layers 111.

Here, the first-direction dimension of the dielectric layer 111 may refer to the first-direction dimension of the dielectric layer 111 disposed between the first and second internal electrodes 121 and 122.

Meanwhile, the first-direction dimension of the dielectric layer 111 may refer to the dimension, distance, size, or length of the dielectric layer 111 in the first direction or may refer to a thickness of the dielectric layer 111.

Here, the first-direction dimension of the dielectric layer 111 may be a concept including the first-direction dimension of at least one of the plurality of dielectric layers 111 or may be a concept including the first-direction dimension of each of all the dielectric layers 111.

In addition, the first-direction dimension of the dielectric layer 111 may refer to a first-direction average dimension of one dielectric layer, may refer to a first-direction average dimension of each of the plurality of dielectric layers 111, or may refer to a first-direction average dimension of the plurality of dielectric layers 111.

The first-direction average dimension of the dielectric layer 111 may be measured by scanning an image of the first- and third-direction cross-sections of the body 110 with a scanning electron microscope (SEM) at 10,000× magnification. More specifically, the first-direction average dimension of one dielectric layer may refer to an average value calculated by measuring first-direction dimensions at five points of one dielectric layer at equal intervals in the third direction in the scanned image. The five equally spaced points may be designated in the capacitance formation portion. In addition, if the average value measurement is extended to three dielectric layers to measure an average value, the first-direction average dimension of a plurality of dielectric layers may be further generalized.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately arranged to face each other with the dielectric layer 111 constituting the body 110 interposed therebetween. The first and second internal electrodes 121 and 122 may be electrically separated from each other by the dielectric layer 111 interposed therebetween in the first direction. In addition, the internal electrodes 121 and 122 may be spaced apart from the third to sixth surfaces 3, 4, 5, and 6.

Here, the internal electrodes 121 and 122 may be connected to the electrodes 131, 132, 133, and 134 penetrating through the body 110 in the first direction described below or may be spaced apart from each other with insulating portions 151 and 152 interposed therebetween.

Specifically, the first internal electrode 121 may be connected to the first and third electrodes 131 and 133 and spaced apart from the second and fourth electrodes 132 and 134. More specifically, the first internal electrode 121 may be disposed to be in contact with the second electrode layers 131b and 133b of the first and third electrodes and may be spaced apart from the second electrode layers 132b and 134b of the second and fourth electrodes with the first insulating portion 151 interposed therebetween.

The first insulating portion 151 may be a region in which a first internal electrode pattern is not disposed when forming the first internal electrode pattern becoming the first internal electrode 121, may be formed by filling a material included in the dielectric layer 111, or may correspond to at least a portion of the dielectric layer 111. The first internal electrode 121 and the second and fourth electrodes 132 and 134 may be electrically insulated by the first insulating portion 151.

The second internal electrode 122 may be connected to the second and fourth electrodes 132 and 134 and spaced apart from the first and third electrodes 131 and 133. More specifically, the second internal electrode 122 may be disposed to be connected in contact with the second electrode layers 132b and 134b of the second and fourth electrodes, and may be disposed to be spaced apart from the second electrode layers 131b and 133b of the first and third electrodes with the second insulating portion 152 therebetween.

The first insulating portion 151 may be a region in which a second internal electrode pattern is not disposed when forming the second internal electrode pattern becoming the second internal electrode 122, may be formed by filling a material included in the dielectric layer 111, or may be at least a portion of the dielectric layer 111. The second internal electrode 122 and the first and third electrodes 131 and 133 may be electrically insulated by the second insulating portion 151.

The diameter of the first and second insulating portions 151 and 152 may be D1, and D1 is not particularly limited as long as it has a size sufficient to form through-holes 141, 142, 143, and 144 to be filled with the second electrode layers 131b, 132b, 133b, and 134b and the third electrode layers 131c, 132c, 133c, and 134c. Here, the first and second insulating portions 151 and 152 may be a substantially circular band shape, and the diameter D1 of the first and second insulating portions 151 and 152 may refer to an average value of any two diameter sizes sharing the center of the first and second insulating portions 151 and 152 (which may refer to the same point as the center of two circular lines constituting the circular band). Here, the diameter D1 of the first and second insulating portions 151 and 152 may refer to the diameter D1 of each of the first and second insulating portions 151 and 152.

The body 110 may be formed by alternately stacking a first ceramic green sheet on which a first internal electrode pattern is printed and a second ceramic green sheet on which a second internal electrode pattern is printed and then firing the same. Here, the first and second internal electrode patterns may be formed by applying an internal electrode paste, and after firing, the first and second internal electrode patterns may become the first and second internal electrodes 121 and 122, respectively. As a method of applying the conductive paste for internal electrodes, a screen-printing method or a gravure printing method may be used, but the present disclosure is not limited thereto.

A material forming the internal electrodes 121 and 122 is not particularly limited and may include a conductive metal with excellent electrical conductivity as a main component. The conductive metal, which is the main component included in the internal electrodes 121 and 122, may be referred to as a fifth conductive metal to be distinguished from the first to fourth conductive metals described below.

In addition, the “main component” in the present disclosure may refer to a component accounting for a relatively large weight ratio or atomic number ratio compared to other components and may refer to a component exceeding 50 wt % based on the weight of the entire material of a corresponding configuration, a component exceeding 50 at % based on the number of atoms, or a component exceeding 50 mol % based on the number of moles.

The fifth conductive metal included in the internal electrodes 121 and 122 may include, for example, one or more selected from the group consisting of nickel (Ni), copper (Cu), palladium (Pd), silver (Ag), gold (Au), platinum (Pt), tin (Sn), tungsten (W), titanium (Ti), and alloys thereof and may preferably include nickel (Ni) as the main component.

Meanwhile, the first-direction dimension of the internal electrodes 121 and 122 may not be particularly limited.

However, in order to more achieve easily miniaturization and high capacitance of the multilayer electronic component, the first-direction dimension of the internal electrodes 121 and 122 may be 2.0 μm or less, 1.0 μm or less, 0.8 μm or less, 0.6 μm or less, 0.5 μm or less, or 0.4 μm or less.

Here, the first-direction dimension of the internal electrodes 121 and 122 may be a concept including the first-direction dimension of at least one of the plurality of internal electrodes 121 and 122 or may be a concept including the first-direction dimension of each of both the internal electrodes 121 and 122.

Here, the first-direction dimension of the internal electrode 121 and 122 may refer to the dimension, size, or length of the internal electrodes 121 and 122 in the first direction or may refer to the thickness of the internal electrodes 121 and 122.

Here, the first-direction dimension of the internal electrodes 121 and 122 may be a concept including the first-direction dimension of at least one of the plurality of internal electrodes 121 and 122 or may be a concept including the first-direction dimension of each of both the internal electrodes 121 and 122.

Here, the first-direction dimension of the internal electrodes 121 and 122 may refer to the first-direction average dimension of one of the internal electrodes 121 and 122, may refer to the first-direction average dimension of each of the plurality of internal electrodes 121 and 122, or may refer to the first-direction average dimension of the plurality of internal electrodes 121 and 122.

The first-direction average dimension of the internal electrodes 121 and 122 may be measured by scanning an image of the first- and third-direction cross-sections of the body 110 with a scanning electron microscope (SEM) at 10,000× magnification. More specifically, the first-direction average dimension of one internal electrode may be an average value calculated by measuring first-direction dimensions at five points of one internal electrode at equal intervals in the third direction in the scanned image. The five equally spaced points may be designated in the capacitance formation portion. In addition, if the average value measurement is extended to three internal electrodes to measure an average value, the first-direction average dimension of a plurality of dielectric layers may be further generalized.

Meanwhile, the body 110 may include cover portions 112 and 113 disposed on both first-direction end surfaces the capacitance formation portion.

Specifically, the body 110 may include a first cover portion 112 disposed on one surface of the capacitance formation portion in the first direction and a second cover portion 113 disposed on the other surface of the capacitance formation portion in the first direction. More specifically, for example, the body 110 may include an upper cover portion 112 disposed on an upper surface of the capacitance formation portion in the first direction and a lower cover portion 113 disposed on a lower surface of the capacitance formation portion in the first direction.

The first cover portion 112 and the second cover portion 113 may be formed by arranging or stacking a single second dielectric layer or two or more second dielectric layers on the upper and lower surfaces of the capacitance formation portion in the first direction, respectively, and may basically play a role of preventing damage to the internal electrodes 121 and 122 due to physical or chemical stress.

The first cover portion 112 and the second cover portion 113 may not include the internal electrodes 121 and 122 and may include the same dielectric material as the first dielectric layer 111 of the capacitance formation portion. That is, the first cover portion 112 and the second cover portion 113 may include a ceramic material, for example, a barium titanate (BaTiO₃)-based ceramic material.

Meanwhile, the first-direction dimension of the cover portions 112 and 113 may not be particularly limited, and the description of the first-direction dimension of the cover portions 112 and 113 below may refer to the first-direction dimension of each of the first cover portion 112 and the second cover portion 113.

However, in order to more easily achieve miniaturization and high capacitance of the multilayer electronic component, the first-direction dimension of the cover portions 112 and 113 may be 100 μm or less, 50 μm or less, 30 μm or less, or 20 μm or less.

Here, the first-direction dimension of the cover portions 112 and 113 may refer to the dimension, distance, size, or length of the cover portions 112 and 113 in the first direction or may refer to the thickness of the cover portions 112 and 113.

In addition, the first-direction dimension of the cover portions 112 and 113 may refer to the first-direction average dimension of each of the first and second cover portions 112 and 113 or may refer to the first-direction average dimension of the first and second cover portions 112 and 113.

The first-direction average dimension of the cover portions 112 and 113 may be measured by scanning an image of the first- and third-direction cross-sections of the body 110 with a scanning electron microscope (SEM) at 10,000× magnification. More specifically, the first-direction average dimension of the cover portions 112 and 113 may refer to an average value calculated by measuring first-direction dimensions at five points of one cover portion at equal intervals in the third direction in the scanned image.

In an embodiment of the present disclosure, the structure in which the multilayer electronic component 100 has four electrodes 131, 132, 133, and 134 is described, but the number or shape of the electrodes 131, 132, 133, and 134 may be changed depending on the shape of the internal electrodes 121 and 122 or other purposes.

The electrodes 131, 132, 133, and 134 may be arranged on the body 110 and connected to the internal electrodes 121 and 122.

Meanwhile, the electrodes 131, 132, 133, and 134 arranged on the body 110 may include at least a portion of a square region and at least a portion of a circular region, but are not particularly limited thereto, and may include at least a portion of a semicircular region and at least a portion of a circular region, and may include at least a portion of a triangular region and at least a portion of a circular region. That is, shapes of the electrodes 131, 132, 133, and 134 are not particularly limited.

The electrodes 131, 132, 133, and 134 may include any material having electrical conductivity, such as metal, and a specific material may be determined in consideration of electrical characteristics, structural stability, and the like and may further have a multilayer structure.

More specifically, the electrodes 131, 132, 133, and 134 may be disposed across the first and second surfaces 1 and 2 by penetrating through the body 110. In other words, the electrodes 131, 132, 133, and 134 may be disposed on the first surface 1, may penetrate through the inside of the body 110 in the first direction so as to be disposed inside the body 110, and may be disposed on the second surface 2, and may be disposed continuously across the first surface 1, the inside of the body 110, and the second surface 2.

Specifically, the electrodes 131, 132, 133, and 134 may include first electrode layers 131a, 132a, 133a, and 134a disposed on the first and second surfaces 1 and 2 and including a first conductive metal as a main component, second electrode layers 131b, 132b, 133b, and 134b arranged to penetrate through the body 110 in the first direction to contact the internal electrodes 121 and 122 and including a second conductive metal as a main component, and third electrode layers 131c, 132c, 133c, and 134c contacting the second electrode layers 131b, 132b, 133b, and 134b, penetrating through the body 110 in the first direction so as to be arranged on the first electrode layers 131a, 132a, 133a, and 134a, and including a third conductive metal as a main component. Furthermore, the electrodes 131, 132, 133, and 134 may include fourth electrode layers 131d, 132d, 133d, and 134d disposed on the third electrode layers 131c, 132c, 133c, and 134c, but are not particularly limited thereto.

Here, it may be preferable that the first to fourth electrode layers are distinguished from each other. However, without being limited thereto, the first to fourth electrode layers may be distinguished according to the manufacturing process order, and at least some of the first to fourth electrode layers may not be distinguished from each other and may be observed as one layer.

In the present disclosure, “distinguished” may refer to that two layers are distinguished due to physical differences, chemical differences, and/or simple optical differences, and layers may be, but are not limited to, distinguished from each other by the presence or absence of an “interface.” The interface may refer to a surface by which two layers in contact with each other are distinguishable from each other, and may refer to, for example, a state in which two layers are distinguishable through differences in components, such as EDS analysis, using equipment, such as a scanning electron microscope (SEM).

In addition, as described above, although not all are shown in the drawings, for convenience of description, the first to fourth electrodes 131, 132, 133, and 134 may include the first electrode layers 131a, 132a, 133a, and 134a, the second electrode layers 131b, 132b, 133b, and 134b, and the third electrode layers 131c, 132c, 133c, and 134c, and further include fourth electrode layers 131d, 132d, 133d, and 134d.

The first electrode layers 131a, 132a, 133a, and 134a may be disposed on the first and second surfaces 1 and 2, and more preferably, may be disposed only on the first and second surfaces 1 and 2. Here, being disposed on the first and second surfaces 1 and 2 may refer to being disposed on a portion or at least a portion of the first and second surfaces 1 and 2. Also, being disposed only on the first and second surfaces 1 and 2 may refer to not being disposed on the third to sixth surfaces 3, 4, 5, and 6 or may refer to not being disposed inside the body 110 or penetrating through the body 110 to be disposed inside the body 10.

Since the first electrode layers 131a, 132a, 133a, and 134a are disposed only on the first and second surfaces 1 and 2, the third electrode layers 131c, 132c, 133c, and 134c may be arranged more uniformly and easily, and the shape of external electrodes that the present disclosure intends to form may be easily manufactured. Also, since the first electrode layers 131a, 132a, 133a, and 134a are not disposed on the third to sixth surfaces 3, 4, 5, and 6, the size of the external electrodes may be reduced, thereby reducing the size of the multilayer electronic component, which may be advantageous for mounting on or inside a substrate and the dielectric capacitance may be further improved.

Here, the first-direction average dimension of the first electrode layers 131a, 132a, 133a, and 134a may be 1 μm or more and 10 μm or less and the first electrode layers 131a, 132a, 133a, and 134a may have a uniform thickness within an error of ±10% based on the first-direction average dimension.

Here, since the first-direction average dimension of the first electrode layers 131a, 132a, 133a, and 134a satisfies 1 μm or more and 10 μm or less, the dielectric capacitance may be excellent.

If the first-direction average dimension of the first electrode layers 131a, 132a, 133a, and 134a is less than 1 μm, it may be difficult to control the shape of the electrode 131, 132, 133, and 134 including the third electrode layers 131c, 132c, 133c, and 134c, and if the first-direction average dimension of the first electrode layers 131a, 132a, 133a, and 134a exceeds 10 μm, there is a concern that the dielectric capacitance characteristics deteriorate compared to multilayer electronic components of the same size.

Here, the first-direction dimension or the first-direction average dimension of the first electrode layers 131a, 132a, 133a, and 134a may refer to the first-direction dimension or the first-direction average dimension of the respective first electrode layers 131a, 132a, 133a, and 134a of the first to fourth electrodes 131, 132, 133, and 134.

Here, the first-direction dimension or the first-direction average dimension of the first electrode layers 131a, 132a, 133a, and 134a may be measured by scanning an image of the first- and third-direction cross-sections using a scanning electron microscope (SEM), but is not limited thereto. More specifically, the first-direction average dimension of one first electrode layer may refer to an average value calculated by measuring the first-direction dimension at three points of one first electrode layer at equal intervals in the third direction in the scanned image, and the first-direction dimensions measured at the three points may have an error within ±10% based on the first-direction average dimension.

The first electrode layers 131a, 132a, 133a, and 134a may be formed by printing a first electrode layer paste including a first conductive metal on the body 110, the second electrode layers 131b, 132b, 133b, and 134b may be formed by forming a plating including a second conductive metal, and the third electrode layers 131c, 132c, 133c, and 134c may be formed by forming a plating including a third conductive metal. Furthermore, the fourth electrode layers 131d, 132d, 133d, and 134d may be formed in a manner of forming a plating including a fourth conductive metal.

The first conductive metal included in the first electrode layers 131a, 132a, 133a, and 134a may be a material having excellent electrical conductivity and may include, for example, at least one selected from the group consisting of nickel (Ni), copper (Cu), palladium (Pd), silver (Ag), gold (Au), platinum (Pt), tin (Sn), tungsten (W), titanium (Ti), and alloys thereof, preferably nickel (Ni), and may more preferably include nickel (Ni) as a main component.

The second electrode layers 131b, 132b, 133b, and 134b may play a role of improving the connectivity and bonding strength with the internal electrodes 121 and 122.

The second conductive metal included in the second electrode layers 131b, 132b, 133b, and 134b may be a material having excellent electrical conductivity and may include, for example, at least one selected from the group consisting of nickel (Ni), copper (Cu), palladium (Pd), silver (Ag), gold (Au), platinum (Pt), tin (Sn), tungsten (W), titanium (Ti), and alloys thereof, preferably nickel (Ni), and may more preferably include nickel (Ni) as a main component.

The second electrode layers 131b, 132b, 133b, and 134b may be formed by forming the through-holes 141, 142, 143, and 144 penetrating through the interior of the body 110 in which the first electrode layers 131a, 132a, 133a, and 134a are formed and then filling the through-holes 141, 142, 143, and 144 with a second conductive metal by plating. Accordingly, the second electrode layers 131b, 132b, 133b, and 134b may include a region in contact with the internal electrodes 121 and 122 and a region not in contact with the internal electrodes 121 and 122 and spaced apart from the internal electrodes 121 and 122 with the insulating portions 151 and 152 interposed therebetween, that is, a region in contact with the insulating portions 151 and 152. Bonding strength may not be good in the region in which the second electrode layers 131b, 132b, 133b, and 134b are in contact with the insulating portions 151 and 152, but when the second conductive metal is the same as the fifth conductive metal, which is the main component of the internal electrodes 121 and 122, the bonding strength may be excellent in the region in contact with the internal electrodes 121 and 122. In addition, even if the third conductive metal included in the third electrode layers 131c, 132c, 133c, and 134c described below and the second conductive metal are different, the bonding strength may be good, and thus, the electrical characteristics may be improved using the third conductive metal as a metal with excellent electrical characteristics.

That is, the second conductive metal may preferably be the same as the fifth conductive metal, which is the main component included in the internal electrodes 121 and 122, and may preferably be different from the third conductive metal, which is the main component included in the third electrode layers 131c, 132c, 133c, and 134c.

The third electrode layers 131c, 132c, 133c, and 134c may play a role of improving the mounting characteristics or may play a role of improving the electrical connectivity or improving the electrical characteristics.

The third conductive metal included in the third electrode layers 131c, 132c, 133c, and 134c may be a material having excellent electrical conductivity, and may include, for example, at least one selected from the group consisting of nickel (Ni), copper (Cu), palladium (Pd), silver (Ag), gold (Au), platinum (Pt), tin (Sn), tungsten (W), titanium (Ti), and alloys thereof, may preferably include copper (Cu), and more preferably may include copper (Cu) as a main component. However, as described above, a metal different from the second conductive metal, for example, a metal having excellent electrical properties may be used, an economical metal may be used, or a metal having excellent mechanical strength may be used to improve the characteristics of the multilayer electronic component 100.

The third electrode layers 131c, 132c, 133c, and 134c may be formed by penetrating through the second electrode layers 131b, 132b, 133b, and 134b filling the through-holes 141, 142, 143, and 144 to have a diameter less than that of the through-holes 141, 142, 143, and 144 and then filling the same with the third conductive metal by plating. Accordingly, the third electrode layers 131c, 132c, 133c, and 134c may be disposed in contact with and inside the second electrode layers 131b, 132b, 133b, and 134b and may extend therefrom to cover the first electrode layers 131a, 132a, 133a, and 134a disposed on the first and second surfaces 1 and 2. In other words, the third electrode layers 131c, 132c, 133c, and 134c may be disposed in contact with and inside the second electrode layers 131b, 132b, 133b, and 134 and may extend therefrom to cover the first electrode layers 131a, 132a, 133a, and 134a. The fourth electrode layers 131d, 132d, 133d, and 134d may play a role of improving mounting characteristics.

The fourth conductive metal included in the fourth electrode layers 131d, 132d, 133d, and 134d may be a material having excellent electrical conductivity, and for example, may include at least one selected from the group consisting of nickel (Ni), copper (Cu), palladium (Pd), silver (Ag), gold (Au), platinum (Pt), tin (Sn), tungsten (W), titanium (Ti), and alloys thereof, may preferably include at least one selected from the group consisting of nickel (Ni), tin (Sn), copper (Cu), and alloys thereof, and may more preferably include at least one of nickel (Ni), tin (Sn), copper (Cu), and alloys thereof as a main component. However, without being limited thereto, the fourth electrode layer 131c, 132c, 133c, and 134c may include a plurality of layers including the fourth conductive metal.

The fourth electrode layers 131d, 132d, 133d, and 134d may be disposed to cover the third electrode layers 131c, 132c, 133c, and 134c. In other words, the fourth electrode layers 131d, 132d, 133d, and 134d may be disposed on the third electrode layers 131c, 132c, 133c, and 134c.

Meanwhile, the first and third electrodes 131 and 133 may be disposed to face each other diagonally, and the second and fourth electrodes 132 and 134 may be disposed to face each other diagonally in positions intersecting the first and third electrodes 131 and 133.

Here, when a gap between two of the third electrode layers adjacently arranged in the second direction, among the third electrode layers 131c, 132c, 133c, and 134c of the first to fourth electrodes, is L1, and a gap between two of the third electrode layers adjacently arranged in the third direction, among the third electrode layers 131c, 132c, 133c, and 134c of the first to fourth electrodes, is L2, 0.9≤L2/L1≤1.1 may be satisfied. More specifically, for example, when the second-direction gap between the third electrode layer 133c of the third electrode and the third electrode layer 134c of the fourth electrode is L1 and the third-direction gap between the third electrode layer 132c of the second electrode and the third electrode layer 133c of the third electrode is L2, 0.9≤L2/L1≤1.1 may be satisfied.

Since an embodiment of the present disclosure satisfies 0.9≤L2/L1≤1.1, the number of magnetic flux linkages per unit current in a high frequency range may be minimized or a current loop may be minimized, so that the high frequency characteristic (low ESL) may be satisfied.

The method of measuring L1 and L2 may be obtained by observing or measuring the second- and third-direction cross-sections. Alternatively, the measurement may be performed in the following manner, but is not particularly limited thereto. The third electrode layers 131c, 132c, 133c, and 134c may also be disposed on the first and second surfaces 1 and 2 of the body, and at least a portion of the third electrode layers 131c, 132c, 133c, and 134c overlapping the insulating portions 151 and 152 or the through-holes 141, 142, 143, and 144 in the first direction may have a low first-direction dimension, size, or height compared to regions not overlapping the insulating portions 151 and 152 or the through-holes 141, 142, 143, and 144 in the first direction, which may cause a step to occur. That is, the first to fourth electrodes 131, 132, 133, and 134 may be disposed on the first and second surfaces 1 and 2 to correspond to the first and second insulating portions 151 and 152, and the regions of the first to fourth electrodes 131, 132, 133, and 134 corresponding to the first and second insulating portions 151 and 152 may have low steps. Accordingly, the regions with low steps, among the first to fourth electrodes 131, 132, 133, and 134, may be regarded as regions in which the third electrode layers 131c, 132c, 133c, and 134c are arranged, and by measuring the second-direction gap and the third-direction gap between the centers of the regions with low steps, L1 and L2 may be obtained.

Also, the diameter of the first to fourth electrodes 131, 132, 133, and 134 disposed on the first and second surfaces 1 and 2 to correspond to the shapes of the first and second insulating portions 151 and 152 may correspond to D2, and D2 may be sufficient if it is an area covering the second electrode layers 131b, 132b, 133b, and 134b or may be sufficient if it is an area covering the third electrode layers 131c, 132c, 133c, and 134c, and is not particularly limited. Meanwhile, the diameter D1 of the first and second insulating portions 151 and 152 may be 1 μm or greater than the diameter D2 of the first to fourth electrodes 131, 132, 133, and 134 disposed on the first and second surfaces 1 and 2 to correspond to the shapes of the first and second insulating portions 151 and 152, preferably 3 μm or larger, more preferably 5 μm or larger. In other words, 1 μm≤D1-D2 may be satisfied.

Since D1 and D2 satisfy 1 μm≤D1-D2, a short may and the electrical be prevented from occurring characteristics may be excellent.

In the case of D1-D2<1 μm, a short may occur more easily, which may cause a defect in the multilayer electronic component 100.

Meanwhile, the size of the multilayer electronic component 100 is not particularly limited. The first-direction dimension (e.g., thickness) of the multilayer electronic component 100 may be referred to as T, the second-direction dimension (e.g., length) as L, and the third-direction dimension (e.g., width) as W. Here, the first-direction dimension may refer to the first-direction average dimension of the multilayer electronic component, the second-direction dimension may refer to the second direction average dimension of the multilayer electronic component, and the third-direction dimension may refer to the third direction average dimension of the multilayer electronic component, which are not particularly limited thereto and may refer to generally used numerical values. Here, the first-direction average dimension T of the multilayer electronic component 100 may satisfy 30 μm≤T≤3/4×W, the third-direction average dimension W may satisfy W≤750 μm, and the third-direction average dimension W and the second direction average dimension L may satisfy 1.75≤W/L≤2.25.

Since the first-direction average dimension T, the second-direction average dimension L, and the third-direction average dimension W of the multilayer electronic component 100 satisfy the above conditions, noise of a high-speed integrated circuit (IC) may be reduced and the multilayer electronic component 100 may be applied to a land side capacitor (LSC).

Hereinafter, the present disclosure will be described in more detail through experimental examples, but this is to help a specific understanding of the disclosure and the scope of the present disclosure is not limited by the preferred experimental examples.

### Experimental Example

Experimental Examples 1 to 6 are sample chips manufactured to include a body including a dielectric layer and an internal electrode and electrodes arranged across the first and second surfaces of the body through the body in the first direction and connected to the internal electrode. Here, the electrodes include a first electrode layer disposed on first and second surfaces of the body, a second electrode layer disposed to be in contact with the internal electrodes through the body in the first direction, and a third electrode layer in contact with the second electrode layer and disposed across the first electrode layer through the body in the first direction. Here, the second electrode layer and the third electrode layer were manufactured to have different main component metals. Here, the sample chip was manufactured to include a region in which one internal electrode and one electrode are connected and a region in which another internal electrode and another electrode are not connected and are spaced apart with an insulating portion therebetween.

[Table 1] below describes the incidence (%) of short of Experimental Examples 1 to 6 by manufacturing a difference value (D1-D2 (μm)) between the diameter D1 of the insulating portion and the diameter D2 of the electrodes disposed on the first and second surfaces of the body in the first direction to correspond to the shape of the insulating portion to be different for each of Experimental Examples 1 to 6.

The incidence (%) of short is calculated by manufacturing 100 sample chips for each Experimental Example, measuring the insulation resistance (IR) when a voltage of 1 Vr is applied using an insulation resistance meter (KEYSIGHT 4339B), evaluating a sample chip identified as “OVLD” outside an impedance measurement range as a sample chip in which a short occurred, and describing the ratio of the number of chips in which a short occurred to the total number of sample chips by a percentage.

TABLE 1

| Sample | D1-D2 (μm) | Incidence of short (%) |
|---|---|---|
| Experimental Example 1 | −1 | 100% |
| Experimental Example 2 | 0 | 100% |
| Experimental Example 3 | 1 | 24% |
| Experimental Example 4 | 3 | 11% |
| Experimental Example 5 | 5 | 3% |
| Experimental Example 6 | 20 | 0% |

As can be seen in Experimental Examples 1 and 2, when the D1-D2 (μm) values are −1 μm or 0 μm, i.e., respectively, that is, less than 1 μm (D1-D2<1 μm), short circuits occur in all sample chips. Meanwhile, as can be seen in Experimental Examples 3 to 6, when the D1-D2 (μm) values are 1 μm, 3 μm, 5 μm, or 20 μm, i.e., 1 μm or more (1 μm≤D1-D2), short circuits do not occur in at least some sample chips and electrical characteristics are improved.

One of the various effects of the present disclosure is to provide a multilayer electronic component with improved high-frequency characteristics (low ESL).

One of the various effects of the present disclosure is to provide the multilayer electronic component implementing low equivalent series resistance (low ESR).

One of the various effects of the present disclosure is to provide the (ultra) small multilayer electronic component.

One of the various effects of the present disclosure is to provide the multilayer electronic component with excellent capacitance characteristics.

One of the many effects of the present disclosure is to provide the multilayer electronic component with improved reliability.

However, the various advantageous advantages and effects of the present disclosure are not limited to the aforementioned contents and will be more easily understood in the process of describing specific embodiments of the present disclosure.

Although the embodiments of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an exemplary embodiment or one example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the example embodiments. As used herein, the singular forms “a,” “an” and “the” are intended to include the plural forms as well, unless the context clearly indicates otherwise.

What is claimed is:

1. A multilayer electronic component comprising:
a body including a dielectric layer and internal electrodes alternately arranged with the dielectric layer in a first direction and including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an electrode including a first electrode layer, a second electrode layer, and a third electrode layer,
wherein the first electrode layer is disposed on the first and second surfaces and includes a first conductive metal as a main component,
the second electrode layer penetrates through the body in the first direction to contact the internal electrodes and includes a second conductive metal as a main component, and
the third electrode layer is disposed on the first electrode layer, includes a third conductive metal as a main component, contacts with the second electrode layer, and penetrates through the body in the first direction, and
the second and third conductive metals are different metals.

2. The multilayer electronic component of claim 1, wherein the internal electrodes include a fifth conductive metal as a main component, and
the second and fifth conductive metals are the same metal.

3. The multilayer electronic component of claim 1, wherein
the internal electrodes include first and second internal electrodes,
the electrode includes first to fourth electrodes,
the first internal electrode is connected to the first and third electrodes and spaced apart from the second and fourth electrodes,
the second internal electrode is connected to the second and fourth electrodes and spaced apart from the first and third electrodes,
the first and third electrodes are arranged to face each other diagonally, and the second and fourth electrodes are arranged to face each other diagonally in positions intersecting the first and third electrodes, and
0.9≤L2/L1≤1.1 in which L1 is a gap between two third electrode layers adjacently arranged in the second direction, among the third electrode layers of the first to fourth electrodes and L2 is a gap between two electrodes adjacently arranged in the third direction, among the third electrode layers of the first to fourth electrodes.

4. The multilayer electronic component of claim 1, wherein
the internal electrodes include first and second internal electrodes,
the electrode includes first to fourth electrodes,
the first internal electrode is connected to the first and third electrodes and spaced apart from the second and fourth electrodes,
the second internal electrode is connected to the second and fourth electrodes and spaced apart from the first and third electrodes, and
when a region in which the first internal electrode is spaced apart from the second and fourth electrodes is referred to as a first insulating portion and a region in which the second internal electrode is spaced apart from the first and third electrodes is referred to as a second insulating portion, the first to fourth electrodes are arranged on the first and second surfaces to correspond to the first and second insulating portions, and satisfies 1 μm≤D1-D2, in which D1 is a diameter of the first and second insulating portions, and D2 is a diameter of the first to fourth electrodes arranged on the first and second surfaces to correspond to the shape of the first and second insulating portions.

5. The multilayer electronic component of claim 1, wherein an average dimension of the first electrode layer in the first direction is 1 μm or more and 10 μm or less.

6. The multilayer electronic component of claim 1, wherein the electrode further includes a fourth electrode layer disposed on the third electrode layer and including a fourth conductive metal as a main component.

7. The multilayer electronic component of claim 1, wherein the multilayer electronic component satisfies 30 μm≤T≤3/4×W, in which T is an average dimension of the multilayer electronic component in the first direction and W is an average dimension in the third direction.

8. The multilayer electronic component of claim 7, wherein multilayer electronic component satisfies 0.85≤w/L≤1.15, in which L is an average dimension of the multilayer electronic component in the second direction.

9. A multilayer electronic component comprising:
a body including a dielectric layer and internal electrodes alternately arranged with the dielectric layer in a first direction and including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an electrode including a second electrode layer, and a third electrode layer,
wherein the second electrode layer penetrates through the body in the first direction to contact the internal electrodes and includes a second conductive metal as a main component, and
the third electrode layer is disposed on the first electrode layer, includes a third conductive metal as a main component, contacts with the second electrode layer, and penetrates through the body in the first direction, and
the second and third conductive metals are different metals.

10. The multilayer electronic component of claim 1, wherein the electrode includes a first electrode layer, and
the first electrode layer is disposed on the first and second surfaces and includes a first conductive metal as a main component.

11. The multilayer electronic component of claim 1, wherein the internal electrodes include a fifth conductive metal as a main component, and
the second and fifth conductive metals are the same metal.

12. The multilayer electronic component of claim 1, wherein
the internal electrodes include first and second internal electrodes,
the electrode includes first to fourth electrodes,
the first internal electrode is connected to the first and third electrodes and spaced apart from the second and fourth electrodes,
the second internal electrode is connected to the second and fourth electrodes and spaced apart from the first and third electrodes,
the first and third electrodes are arranged to face each other diagonally, and the second and fourth electrodes are arranged to face each other diagonally in positions intersecting the first and third electrodes, and
0.9≤L2/L1≤1.1 in which L1 is a gap between two third electrode layers adjacently arranged in the second direction, among the third electrode layers of the first to fourth electrodes and L2 is a gap between two electrodes adjacently arranged in the third direction, among the third electrode layers of the first to fourth electrodes.
